(19) United States
(12) Patent Application Publication
(10) Pub. No.: US 2026/0365484 A1
(43) Pub. Date: Nov. 19, 2026

(54) HYRDRAULIC BRAKE

(71) Applicant: INVENTIO AG, Hergiswil (CH)

(72) Inventors: Gunnar Fuchs, Luzern (CH); Oliver Simmonds, Luzern (CH)

(21) Appl. No.: 19/139,479

(22) PCT Filed: Dec. 12, 2023
(86) PCT No.: PCT/EP2023/085230

§ 371 Date: Jun. 16, 2025

(30) Foreign Application Priority Data
Dec. 23, 2022 (EP) 22216285.1

(51) Int. Cl. B66B 1/36; B66B 5/18; F16D 59/00; F16D 121/06

(52) U.S. Cl. CPC B66B 1/365; B66B 5/18; F16D 59/00; F16D 2121/06

(57) ABSTRACT

A brake for a traveling body of an elevator includes a housing, a brake clamp, a first brake pad, a second brake pad, and a hydraulic element. The brake clamp implements a clamping force of the brake along a second line of action and transmits the clamping force to the first brake pad and to the second brake pad. The brake clamp engages around the housing. The hydraulic element exerts a release force on the brake clamp along a first line of action in order to widen the brake clamp. Widening the brake clamp releases the brake. The first line of action and the second line of action are spaced apart from each other.

### FIELD

The present invention relates to a brake for an elevator, to a traveling body for an elevator, and to an elevator.

### BACKGROUND

In an elevator system, a car is typically moved vertically along a travel path between different floors or levels within a building. At least in tall buildings, an elevator type is used in which the car is held by rope or belt-like suspension means and displaced within an elevator shaft by moving the suspension means by means of a prime mover. In order to at least partially compensate for the load of the car which must be moved by the prime mover, a counterweight is usually fastened to an opposite end of the suspension means. The car and counterweight are the traveling bodies of the elevator system. In order to protect the traveling bodies from falling along the travel path, the traveling bodies are often equipped with brakes. Such traveling body brakes can be designed as hydraulic brakes.

U.S. Pat. No. 9,688,510B2 discloses a hydraulic brake in which springs for preloading a hydraulic brake are housed in the brake cylinders. U.S. Pat. No. 10,450,165B2 also discloses springs for preloading a hydraulic brake in the brake cylinders. For safety reasons, such springs are typically designed to be preloaded by the springs in a braking position and released by a hydraulic actuator. US 2017/0036888 A1 discloses a hydraulic brake with springs arranged separately on a lever mechanism.

Due to this design, the choice of springs is severely limited. The springs must fit into the corresponding cylinder bores. Since the springs are located in the cylinder bores, replacing or adjusting the springs is relatively difficult.

### SUMMARY

One object can therefore be seen as that of providing a brake that has improved adjustability and maintenance.

According to a first aspect of the invention, the above object is achieved by a brake. The brake for a traveling body of an elevator comprises: a housing, a brake clamp, a first brake pad, a second brake pad, and a hydraulic element. The brake clamp is designed to implement a clamping force of the brake along a second line of action and to transmit this clamping force to the first brake pad and the second brake pad. The brake clamp engages around the housing. The hydraulic element is designed to exert a release force on the brake clamp along a first line of action in order to widen the brake clamp. Widening the brake clamp releases the brake. The first line of action and the second line of action are spaced apart from each other. The brake clamp is designed as a C-spring assembly.

According to a second aspect of the invention, the object is achieved by a traveling body. The traveling body has a brake according to the first aspect of the invention.

According to a third aspect of the invention, the object is achieved by an elevator. The elevator has a brake according to the first aspect of the invention or a traveling body according to the second aspect of the invention.

Possible features and advantages of embodiments of the invention can be regarded, inter alia and without limiting the invention, as being based upon the concepts and findings described below.

The brake for the traveling body of an elevator serves to effect a braking force on a brake rail that counteracts the direction of movement of the traveling body. The traveling body can be a car or a counterweight. The housing is primarily used for attachment to the traveling body, or to a movable attachment option on the traveling body, for example. The hydraulic element is therefore fixed to the housing. The brake clamp is designed to be preloaded and to store energy in the preloaded state in order to apply the energy as a clamping force to the first and second brake pads when required.

The brake clamp can be preloaded by being widened. In order to widen the brake clamp, a release force and/or a clamping force can act upon the brake clamp.

The brake may be activated. Then, no release force acts along the first line of action, because the hydraulic element is retracted. Along the second line of action, the force of the brake clamp, which is still widened even when the brake is activated, is transferred as a clamping force to the first and second brake pads. With this clamping force, the first and second brake pads are pressed onto the brake rail or can be pressed onto the brake rail. The clamping force depends upon the width of the brake clamp. The more the brake clamp is widened, the greater the clamping force becomes. The widening of the brake clamp depends, for example, upon how badly the brake pads are worn. The more worn the brake pads are, the less the brake clamp is widened and the lower the clamping force is. However, the clamping force can also be adjusted by changing the thickness of a variable-thickness preload element. The thicker the adjustment on the preload element, the greater the clamping force becomes. The braking force can also be adjusted via the clamping force.

The brake can be released. Then, no clamping force acts along the second line of action, because the brake pads do not touch the brake rail. Along the first line of action, the hydraulic element is designed to widen the brake clamp. The force applied by the hydraulic system is called the release force. The release force depends upon the widening of the brake clamp. The more the brake clamp is widened by the hydraulic element, the greater the release force becomes. Since the hydraulics widen the brake clamp further than is the case when the brake is activated, the release force of a brake is greater than the clamping force.

In a transition region between the activated brake and the released brake, both the release force and the clamping force can contribute to the widening of the clamping element-for example, half each.

According to a preferred embodiment, a hydraulic bearing and a counter bearing transmit the release force to the brake clamp, wherein the hydraulic bearing and counter bearing are designed as thrust bearing points, and/or a first brake bearing and a second brake bearing transmit the clamping force to the brake clamp, wherein the first brake bearing and the second brake bearing are designed as thrust bearing points.

A thrust bearing point is suitable for transferring a compressive force from a first body to an adjacent second body. Preferably, at least one of the two bodies is curved outwards with a first protruding radius of curvature. Preferably, the other body is flat. Alternatively, the second body can also be curved outwards. It may also be advantageous for the second body to be designed to be curved inwards at the thrust bearing point with a second radius of curvature that is greater than the first radius of curvature. This allows the curvature of the first body to lie stably in the curved depression of the second body. The local curvature geometry can be cylindrical, ellipsoidal, or spherical.

The hydraulic bearing is the thrust bearing point between the brake clamp and the hydraulic element at which the release force exerted by the hydraulic element is transferred to the brake clamp as a pressure force. The counter bearing is the thrust bearing point between the brake clamp and the hydraulic element at which the release force exerted by the hydraulic element is transferred from the housing directly or indirectly as a pressure force to the brake clamp.

The hydraulic bearing and the counter bearing are therefore located on the first line of action. Analogously, the first brake bearing is the thrust bearing point at which the brake clamp transfers the clamping force directly or indirectly to the first brake pad. The second brake bearing is also the thrust bearing point at which the brake clamp transfers the clamping force directly or indirectly to the second brake pad.

The first brake bearing and the second brake bearing are located on the second line of action. The clamping force is transmitted along the second line of action from the first brake bearing to the first brake pad and from the second brake bearing to the second brake pad. The first and second brake pads each press onto the brake rail with the clamping force. This clamping force creates the braking force on the brake rail via friction. The braking force is then transferred from the brake pad via the housing into the traveling body and causes the traveling body to decelerate.

The first and second lines of action preferably run parallel to each other.

The forces on the brake clamp are therefore substantially introduced via the four thrust bearing points. In addition, the brake clamp engages around the housing. The brake clamp is therefore located outside the housing and essentially has only the four thrust bearing points as a connection to the rest of the brake. The brake can therefore, for installation, be easily separated into the housing and one or more brake clamps. The entire brake can be very heavy and would therefore be difficult to install. The housing and one or more brake clamps each have a weight that is easy to handle by a fitter. These individual parts of the brake can, for example, be less than 10 kg or less than 5 kg. This makes the installation of the individual parts, such as the housing or the individual brake clamps, easy. The brake can therefore be easily installed. In addition, the brake clamp is easily accessible outside the housing. The brake clamp is therefore easy to check, maintain, or adjust.

According to a preferred embodiment, the hydraulic element is fixed to the housing. The hydraulic element has a hydraulic piston. The hydraulic piston is designed to press on the hydraulic bearing and thus generate the release force.

In particular, a surface on the hydraulic piston can be designed in such a way that the hydraulic piston can act directly upon the hydraulic bearing. For this purpose, the contact surface of the hydraulic piston towards the hydraulic bearing can be designed to be slightly curved. Alternatively, in particular when multiple hydraulic elements are used, or a hydraulic element with multiple hydraulic pistons is used, the hydraulic bearing can be formed on a further connecting support, viz., a hydraulic support plate. The hydraulic bearing plate distributes the force from one or more hydraulic elements to one or more brake clamps. One hydraulic element can widen multiple brake clamps. Alternatively, multiple hydraulic elements can widen one brake clamp. Furthermore, multiple hydraulic elements can widen multiple brake clamps, wherein the number of hydraulic elements and the number of brake clamps can be identical or different. The widening by the hydraulic element(s) is carried out by applying the release force.

The hydraulic element has a hydraulic cylinder and the hydraulic piston. Preferably, the hydraulic cylinder is attached to the housing or embodied on the housing. The hydraulic piston moves linearly, preferably along the first line of action. The hydraulic element is designed in such a way that it has a small amount of play in the retracted position relative to the brake clamp. In the extended position, the hydraulic element widens the brake clamp so much that the brake pads are lifted off the brake rail, i.e., released.

The release force is generated by the hydraulic element when the brake is released. The release force widens the brake clamp and thereby releases the brake. The first and second brake pads are lifted off the brake rail during the release. The clamping force is effected by the brake clamp, since it is preloaded. When the brake is activated, the clamping force acts upon the brake clamp. Since the hydraulic element does not exert any force on the brake clamp in this state, this clamping force acts mainly upon the first and second brake pads.

Lines of action are straight lines. Forces act upon bodies along the lines of action. When the brake is released, for example, the hydraulic piston presses on the brake clamps. The brake clamp is therefore subjected to an opposing release force at two points. The line of action connects these two points and runs along the direction of the two opposing release forces.

Preferably, the traveling body has at least two brakes. It is also advantageous to operate two brake circuits, each with two brakes, wherein a first brake of the brake circuit can generate a braking force on a first brake rail. A second brake of the same brake circuit can generate an additional braking force on a second brake rail which runs opposite the first brake rail on the traveling body.

The brake clamp can be designed as a brake caliper, wherein the brake caliper comprises a first clamp arm, a second clamp arm, a brake caliper joint, and a brake caliper spring. Preferably, the brake caliper joint is arranged between a brake caliper spring, designed as a compression spring, and the thrust bearing points. The compression spring can, for example, comprise a stack of disc springs. A brake clamp designed in this way can be widened by the hydraulics along the first line of action. Along the second line of action, the caliper brake can exert a clamping force on the first brake pad and the second brake pad. The caliper brake, for example, is held to the housing by clamps. The clamps allow a slight movement relative to the housing, which is caused in particular by the deformation of the caliper brake. However, they ensure that the transmission of the clamping force and the release force is guaranteed.

The four thrust bearing points can be formed on the first and second clamp arms. Preferably, the clamp arms are cast parts, and the curvature of the thrust bearing points can be spherical.

The brake clamp is designed as a C-spring assembly. C-spring assemblies, i.e., assemblies consisting of multiple layers of C-shaped springs, are known from brakes, and in particular from safety gears. They have many advantages over other springs. For example, they have a longer lifespan. In addition, safety is higher, because, even if one of the springs fails, there is only a limited reduction in spring force. The remaining intact springs usually continue to generate a clamping force that is sufficient to safely brake the vehicle.

The four thrust bearing points can be formed on each individual C-shaped spring. Preferably, the C-spring assembly then has a cylindrical shape for the curvature of the thrust bearing points. The contact surface on which the forces are transferred to the thrust bearing points is therefore elongated or linear.

According to a preferred embodiment, a plurality of C-spring assemblies arranged on the housing are widened with a plurality of hydraulic elements; preferably each hydraulic element is assigned exactly one C-spring assembly. This means that the brake has a modular design. A stronger brake can be achieved not only by a stronger C-spring assembly with a higher spring constant, but a stronger brake can also include one or more additional C-spring assemblies. Multiple C-spring assemblies with the same spring constant therefore produce a greater spring force than a single C-spring assembly with the same spring constant. The brake with multiple C-spring assemblies can therefore generate a greater clamping force and thus achieve more braking power.

According to a preferred embodiment, the first brake pad is fixed to the housing, in particular by a first brake pad holder.

Along the second line of action, the clamping force is transferred from the first brake bearing to the first brake pad. The first brake pad holder is also located on the second line of action. The brake pad holder can have a curvature on the side facing the brake clamp, or can be flat. Preferably, it has a curved depression into which the curvature of the brake clamp fits.

Facing the brake pad, the brake pad holder is designed in such a way that it can accommodate a brake pad, preferably via a positive connection. The brake pad can also preferably be fastened with screws or other suitable fasteners. The brake pad is preferably replaceable or interchangeable.

According to a preferred embodiment, the second brake pad is guided linearly on the housing. The linear guidance, i.e., the linear guidance of the second brake pad on the housing, preferably takes place in the direction of, and preferably along, the second line of action. The linear guidance can be effected, for example, by plain bearings, needle bearings, or ball bearings.

Alternatively, the first brake pad can be guided linearly on the housing. This can be done via any linear guide. The linear guide can, for example, be designed as a plunger guided in the housing, as is the case with the second brake pad.

According to a preferred embodiment, the linear guide on the housing is realized by a plunger, wherein the plunger is cylindrically shaped and passes through holes on the housing, and the plunger transmits the clamping force from the second brake bearing to the second brake pad.

The lateral surface of the cylindrically designed plunger, together with the lateral surface of the bore, forms a plain bearing in which the plunger can move linearly. The plunger transfers the clamping force from the second brake bearing to the second brake pad. The second brake bearing can in particular be connected directly to the plunger by there being direct contact between the plunger and the second brake bearing, or it can be indirectly connected to the plunger by the brake bearing transmitting the clamping force to other bodies located between the brake bearing and the plunger. The plunger transfers the clamping force to the second brake pad. Preferably, the brake has multiple plungers. For example, each plunger can be assigned to a brake clamp.

A bearing plate may be arranged between the plunger or plungers and the brake clamp or clamps. The bearing plate distributes the clamping force from the brake clamp or clamps to the plunger or plungers. In particular, the bearing plate can transfer the clamping force of multiple brake clamps to one plunger, or the bearing plate can transfer the clamping force of one brake clamp to multiple plungers. In particular, the clamping force of multiple brake clamps can be transferred to multiple plungers, wherein the number of brake clamps and the number of plungers can be identical or different.

The bearing plate may have protruding bulges or recessed depressions that can act as thrust bearing points.

According to a preferred embodiment, an auxiliary spring exerts a preload force on the second brake pad in the direction of the second brake bearing. This causes the second brake pad to be pushed away from the rail as the brake clamp widens. This reliably creates a play between the second brake pad and the rail. The brake can be guided via the guide shoes on the brake rail. Preferably, the guide shoes are attached to the brake housing. This allows the brake to be guided very precisely along the brake rail. In particular, the brake can be guided more precisely than the car to which it is attached. Alternatively, the brake can be fixed to the traveling body and guided via the traveling body guide shoes. The guide reliably maintains the play on both sides of the brake rail during movement. The auxiliary spring ensures that the plunger(s) (or, alternatively, the bearing plate) on the second brake bearing remain in contact with the clamping element(s). This reliably prevents the second brake pad from moving towards the brake rail, without being pressed by the brake clamp.

Alternatively, permanent magnets can be installed in such a way that they create an adherence between the brake clamp and the plunger or the bearing plate on the second brake bearing. This adherence may be suitable for maintaining a distance between the second brake pad and the brake rail. This not only relieves the load on the second brake pad, but also actively pulls it away from the brake rail. This reliably creates a play between the brake rail and the second brake pad. The guide shoes are then preferably arranged in such a way that the housing is aligned with the brake rail in such a way that this play is preferably evenly distributed on both sides of the brake rail.

According to a preferred embodiment, the plunger has a pin for the positive force transmission to the second brake pad, in particular by means of a second brake pad holder. This demonstrates the advantage that the braking forces can be introduced into the plunger via the pin. The plunger(s) then transfer the braking forces to the housing.

The second brake pad can therefore be attached directly to the individual plungers-for example, with screws. Preferably, a second brake pad holder is fixed to the plunger or plungers. The second brake pad holder can be manufactured as one piece with the plunger or plungers.

Preferably, the second brake pad is connected to the plunger via a second brake pad holder. The second brake pad is therefore designed to be replaceable, just like the first brake pad.

According to a preferred embodiment, the first brake pad and/or the second brake pad are replaceable.

Preferably, the first and second brake pads are designed to be replaceable in that a first brake pad holder is fixed to the housing, and a second brake pad holder is fixed to the plunger(s). The first and second brake pads, which are preferably of identical design, can then be easily replaced on the first or second brake pad holder. The brake pads can be screwed to the brake pad holders and/or connected via a non-positive connection.

According to a preferred embodiment, a counter bearing body is removable, and the counter bearing body is designed to press on the counter bearing. The counter bearing body lies on the first line of action. The counter bearing body on its surface can have a curved depression in which the outwardly curved contact surface of the brake clamp rests. In this embodiment, the counter bearing is formed by the contact region of the counter bearing body with the brake clamp. Preferably, the counter bearing body is a cubic block with a curved depression on both sides.

Further advantages, features, and details of the invention can be found in the following description of exemplary embodiments and with reference to the drawings, in which like or functionally like elements are provided with identical reference signs. The drawings are merely schematic and are not to scale.

### DESCRIPTION OF THE DRAWINGS

In the figures:

FIG. 1 is a schematic diagram of an elevator having brakes according to the invention,

FIG. 2 is a section through a brake with a C-spring as a brake clamp according to the invention,

FIG. 3 is a section through a brake with a brake caliper as a brake clamp according to an alternate embodiment of the invention, and

FIG. 4 is a perspective section through the brake shown in FIG. 2.

### DETAILED DESCRIPTION

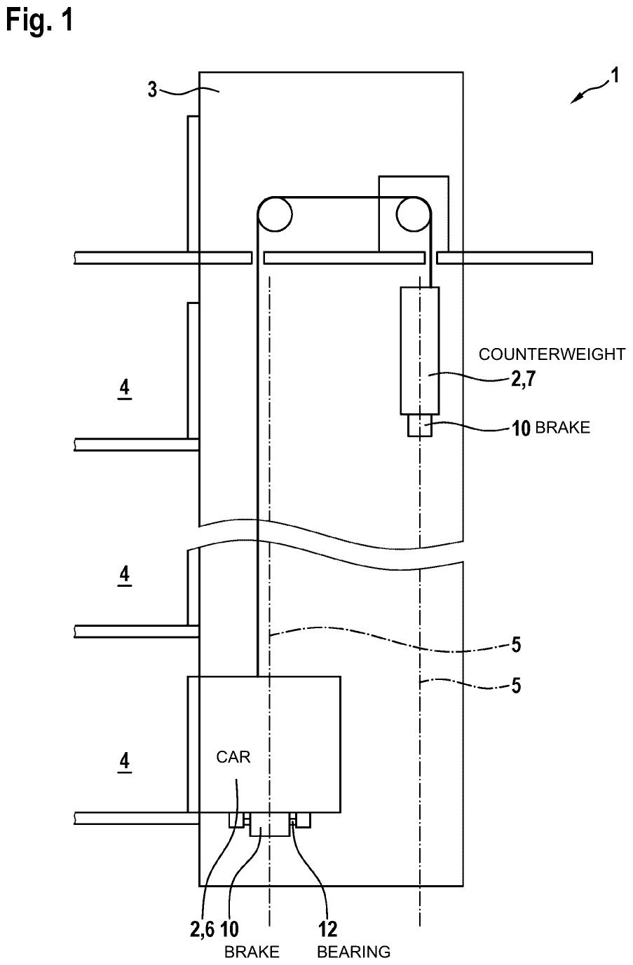

FIG. 1 shows an elevator 1. In an elevator 1, a car 6 is typically moved vertically between different floors 4 or levels inside a building. To compensate for the weight of the car 6, the elevator also has a counterweight 7. The car 6 and counterweight 7 can be referred to as the traveling bodies 2, since they are moved along rails, which also serve as brake rails 5. In order to brake the traveling body when necessary, i.e., to slow it down or to hold it still, they have brakes 10.

For the travel comfort of the passengers, it is advantageous that a traveling body, and in particular the car 6, can easily move horizontally relative to the brake rail 5. The brake rail always has small bumps; thanks to an elastic bearing with 4 to 5 mm play, the car 6 can follow these bumps with a delay. However, the brake preferably only has a play of 1 to 2 mm. Therefore, the brake 10 on the car 6 is guided in a floating manner on a brake plain bearing 12. This allows the brake 10 to reliably follow the bumps of the brake rail 5.

The prime mover, driving the traveling bodies 2, is located in a machine room 3.

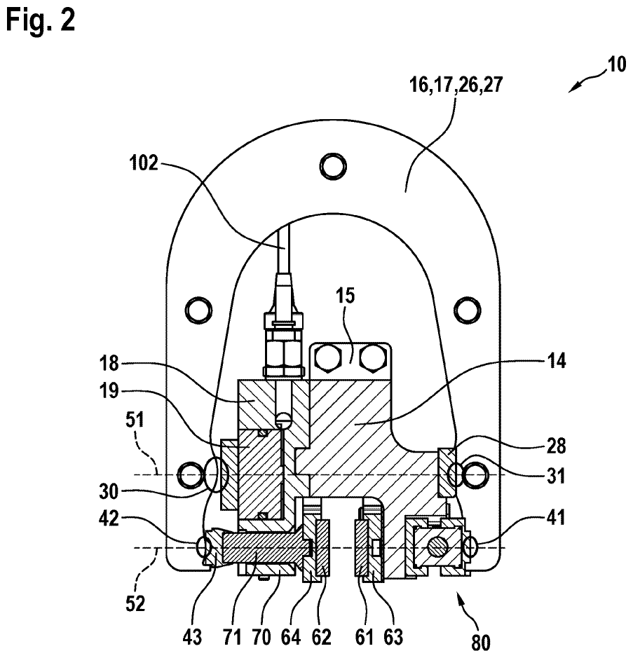

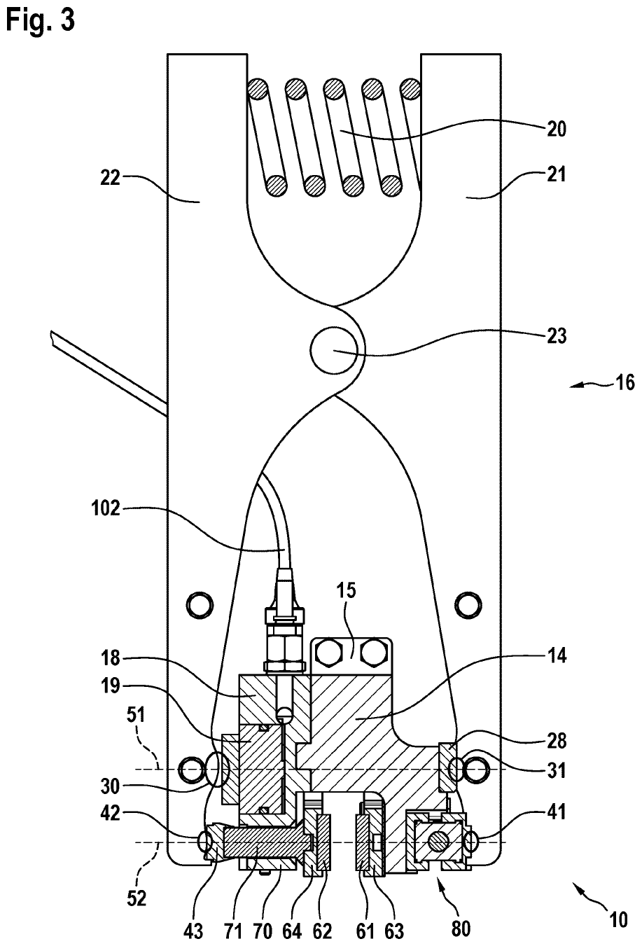

The brake 10 is mounted in a floating manner on the car 6 via a brake plain bearing 12. The brake 10 can therefore move horizontally along the axis of the brake plain bearing 12 in order to be able to reliably follow the bumps of the rail. At the same time, the brake plain bearing 12 can transfer the braking forces to the car 6. Of course, a brake plain bearing 12 can also be provided for the brake 10 on the counterweight 7. (Not shown in FIG. 1 for reasons of clarity) FIG. 2 and FIG. 3 show two alternative embodiments of the brake clamp 16 on an otherwise similar brake 10. A fastening region 15 serves to fasten the brake to a traveling body 2, and in particular to a movable brake plain bearing on the car (see FIG. 1).

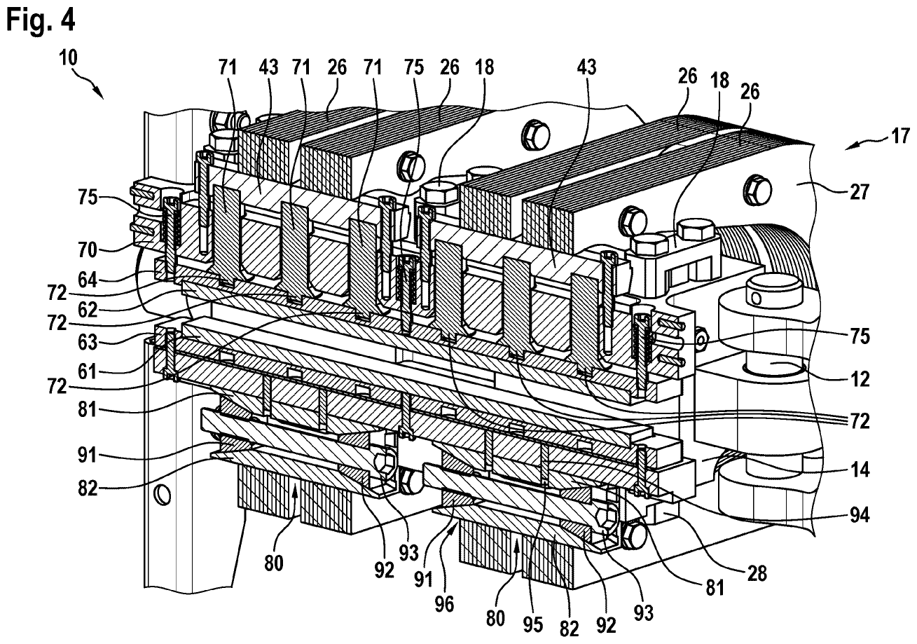

The brake clamp 16 engages around the housing 14 of the brake 10. The brake clamp 16 is designed in such a way that it can widen. In FIG. 2, the brake clamp 16 is designed as a spring 17. The spring 17 is formed by a C-spring assembly 26, which consists of individual C-shaped leaf springs 27. The spring 17 provides the clamping force of the brake 10. (In FIG. 4, the individual C-leaf springs 27 and the C-spring assemblies 26 can be seen better.) In FIG. 3, the brake clamp 16 is designed as a brake caliper. The brake caliper comprises a first clamp arm 21 and a second clamp arm 22, which are connected by a brake caliper joint 23. The first clamp arm 21 and the second clamp arm 22 engage around the housing 14 of the brake 10. The brake caliper has a brake caliper spring 20 to provide the clamping force of the brake caliper.

The hydraulic element 18, in particular the hydraulic piston 19, and the counterholder body 28 are arranged along the first line of action 51. In a braking position, the hydraulic piston 19 is retracted into the hydraulic element 18. In the hydraulic bearing 30, there is preferably a play between the brake clamp 16 and the hydraulic piston 19. There is a play in the counter bearing 31, and the brake clamp is preferably spaced apart from the counterholder body 28. Therefore, no force is transmitted along the first line of action 51.

The clamping force exerted by the brake clamp 16 is transmitted completely along the second line of action 52. In the first brake bearing 41, the clamping force is transmitted to the housing 14 via a preload element 80. The housing 14 is also fixed to the first brake pad holder 63 and the first brake pad 61 held thereon. On the opposite side, on the second brake bearing 42, the clamping force is transferred to the plungers 71 via a bearing plate 43. The plungers 71 are also fixed to the second brake pad holder 64 and the second brake pad 62 held thereon. The plungers 71 are guided in a linear guide 70 so as to be linearly displaceable. The linear guide 70 is designed as a bore. In the braking position, a brake rail is clamped between the first brake pad 61 and the second brake pad 62, thereby generating the braking effect. The brake rail is not shown, but causes the distance between the first brake pad 61 and the second brake pad 62, so that a clamping force acts along the second line of action 52, which widens the brake clamp 16.

In order to reach the released position (not shown in FIG. 2 and FIG. 3), hydraulic fluid is pressed into the hydraulic element 18 via the hydraulic line 102. The hydraulic piston 19 presses on the hydraulic bearing 30. Together with the counterholder body 28 which presses on the counter bearing 31, the brake clamp 16 is thereby widened. As a result, the release force is built up along the first line of action 51. The clamping force transmitted along the second line of action 52 decreases. When the hydraulic piston 19 is fully extended, the first brake pad 61 and the second brake pad 62 have a play relative to the brake rail. The contact at the second brake bearing 42 is maintained. For this purpose, the bearing plate 43 can be designed magnetically so that it moves with the brake clamp 16. Or the plungers 71 are preloaded via auxiliary springs, as shown in FIG. 4.

FIG. 4 is a section through the brake 10 with a C-spring assembly 26, as already shown in FIG. 2. FIG. 4 is a more detailed variant of the embodiment of the brake 10 from FIG. 2. FIG. 4 shows how the C-spring assemblies 26 are formed by stacking individual C-shaped leaf springs 27. Two hydraulic elements 18 each widen two C-spring assemblies 26, so that the brake 10 has four C-spring assemblies 26. Two C-spring assemblies 26 each press on one of two bearing plates 43. Each of the bearing plates 43 is connected to three plungers 71. All six plungers 71 are connected at the other end, by pins 72, to the second brake pad holder 64. The plungers 71 are each mounted in a linear guide 70. The three auxiliary springs 75 serve to lift the second brake pad 62 from the brake rail and to keep the bearing plate 43 in contact with the brake clamp 16 even in the released state.

The two preload elements 80 each have a first support element 81, a second support element 82, a first wedge element 91, and a second wedge element 92. The traction means 93, which is designed here as a screw, runs through a threadless bore in the second wedge element 92 and is screwed into a thread in the first wedge element 91. By tightening the screw, the preload element 80 is widened. The first support element 81 is fixed to the housing 14 by pins 94 inserted in bores 95. A surface 96 of the second support element 82 is designed to contact the C-spring assembly 26 and the first brake bearing 41 that are shown in FIG. 2 or the first clamp arm 21 and the first brake bearing 41 that are shown in FIG. 3.

Finally, it should be noted that terms such as “having,” “comprising,” etc., do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A brake for braking a traveling body of an elevator, the brake comprising:
a housing adapted to be fastened to the traveling body;
a first brake pad, a second brake pad and a hydraulic element mounted on the housing;
a brake clamp engaging around the housing;
wherein the brake clamp is adapted to effect a clamping force along a second line of action and to transmit the clamping force to the first brake pad and to the second brake pad;
wherein the hydraulic element is adapted to effect a release force on the brake clamp along a first line of action to widen the brake clamp, the widening of the brake clamp releasing the brake;
wherein the first line of action and the second line of action are spaced apart from each other; and
wherein the brake clamp is a C-spring assembly.

15. The brake according to claim 14 including a hydraulic bearing and a counter bearing positioned to transmit the release force to the brake clamp, wherein the hydraulic bearing and the counter bearing are each a thrust bearing point.

16. The brake according to claim 15 including a counterholder body attached to the housing, wherein the counterholder body is adapted to press on the counter bearing to transmit the release force.

17. The brake according to claim 14 including a first brake bearing and a second brake bearing positioned to transmit the clamping force from the brake clamp to the first and second brake pads, wherein the first brake bearing and the second brake bearing are each a thrust bearing point.

18. The brake according to claim 14 wherein the hydraulic element is a plurality of hydraulic elements and the C-spring assembly is a plurality of C-spring assemblies, wherein each one of the C-spring assemblies is associated with only one of the hydraulic elements.

19. The brake according to claim 14 wherein the first brake pad is fixed to the housing by a first brake pad holder and/or the second brake pad is fixed to a displaceable second brake pad holder.

20. The brake according to claim 14 wherein the second brake pad is displaceable and is guided linearly on the housing.

21. The brake according to claim 20 including a first brake bearing and a second brake bearing positioned to transmit the clamping force from the brake clamp to the first and second brake pads, and including a bore formed in the housing and a plunger guided in the bore, wherein the plunger transfers the clamping force from the second brake bearing to the second brake pad.

22. The brake according to claim 21 including an auxiliary spring that exerts a preload force on the second brake pad in a direction of the second brake bearing.

23. The brake according to claim 21 wherein the plunger includes a pin transmitting the clamping force to the second brake pad by a second brake pad holder.

24. The brake according to claim 14 wherein the hydraulic element includes a hydraulic piston that is adapted to press on a hydraulic bearing, the hydraulic bearing being positioned between the hydraulic piston and the brake clamp.

25. The brake according to claim 14 wherein the first brake pad and/or the second brake pad are replaceable.

26. A traveling body of an elevator, the traveling body having the brake according to claim 14 attached thereto.

27. An elevator comprising:
a traveling body being an elevator car or a counterweight; and
the brake according to claim 14 attached to the traveling body.
